(19) United States
(12) Patent Application Publication
(10) Pub. No.: US 2020/0389411 A1
(43) Pub. Date: Dec. 10, 2020

(54) METHOD AND SYSTEM FOR ALLOCATING RESOURCES IN A CLOUD-BASED COMMUNICATION SYSTEM

(71) Applicant: MOTOROLA SOLUTIONS, INC, CHICAGO, IL (US)

(72) Inventors: YUNHAI YANG, ELGIN, IL (US); DANIEL J. MCDONALD, CARY, IL (US); CRAIG A. IBBOTSON, CRYSTAL LAKE, IL (US)

(21) Appl. No.: 16/431,960

(22) Filed: Jun. 5, 2019

(51) Int. Cl. H04L 12/911; H04L 29/08

(52) U.S. Cl. CPC H04L 47/70; H04L 67/10

(57) ABSTRACT

A method and system resource allocation in a cloud-based communication system is provided. A cloud-based communication system forecasts a traffic envelope pattern across the cloud-based communication system, preferably via machine learning. The cloud-based communication system sets a potential maximum traffic amount for the cloud-based communication system using cloud platform information and call properties. The cloud-based communication system bounds the potential maximum traffic amount using bounding parameters, and adjusts the traffic envelope pattern based on an incident context. The cloud-based communication system consolidates resources within the cloud-based communication system and adjusts call resource resources in the cloud-based communication system when passive performance monitoring indicates a new burst traffic pattern.

### BACKGROUND OF THE INVENTION

Real-time latency sensitive applications, such as Next Generation Call Processing (NGCP), real-time stock trading, high performance computing, in-memory data management, and IoT controller applications, are designed to use a cloud-based multi-tenant architecture. NGCP servers are designed to process service requests, such as a group call, from all customers. The cloud-based solution has the ability to use both static and dynamic cloud resources. However, static resources carry a fixed cost, regardless if they are used or not. Additionally, dynamic resources can be added but at a significantly higher cost than static resources. Further, adding dynamic resources requires time and must be added such that there is no impact to call services.

Two problems that arises from NGCP servers are Quality of Service (QoS) and Grade of Service (GoS). If required cloud resources are not obtained and useable in a timely manner, the QoS will suffer and may prove to be insufficient for the call needs.

In addition, an inefficient use of cloud resources leads to a higher cost. Idle static resources are not an efficient use of budget, while dynamic resource access is costly.

Therefore, a need exists for a method and system of accessing necessary resources for service requests while minimizing the cost of such services.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a cloud-based communication system in accordance with an exemplary embodiment of the present invention.

FIG. 2 depicts a cloud-based communication application in accordance with an exemplary embodiment of the present invention.

FIG. 3 depicts a flowchart in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An exemplary embodiment provides a method and cloud-based communication system that leverages existing cloud-based technology to predict necessary dynamic resources for Mission Critical deployments. An exemplary embodiment also can enhance the resource prediction model to adjust static resources. The presented method and platform refines the prediction model based on, for example, weighted traffic types, infrastructure info, number of users/subscribers, service types, and amount of call traffic to efficiently predict dynamic resource demand and adjust static resources to remain cost effective.

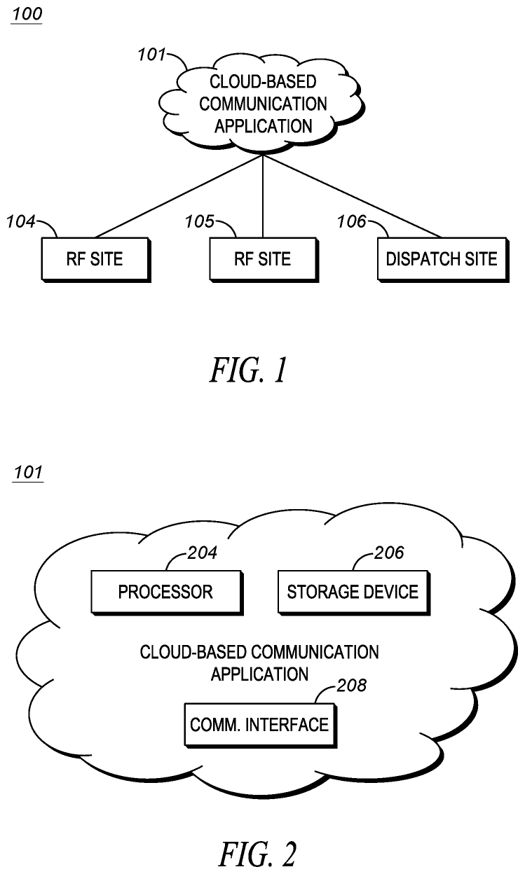

FIG. 1 depicts a system diagram of a cloud-based communication system 100 in accordance with an exemplary embodiment of the present invention. Cloud-based communication system 100 preferably includes cloud-based communication application 101 and a plurality of communication sites, such as RF site 104, RF site 105, and dispatch site 106. Cloud-based communication system 100 preferably supports multiple users across multiple enterprises or agencies. Cloud-based communication system 100 would typically include a plurality of mobile devices, but they are omitted from FIG. 1 for clarity. The mobile devices could be radios, cell phones, computers, landline telephones, two-way radios, etc.

Cloud-Based Communication Application 101 supports multiple users across multiple enterprises or agencies. Cloud-Based Communication Application 101 is described in detail in FIG. 2 below.

Communication sites, such as RF site 104, RF site 105, and dispatch site 106, preferably comprises a single technology. In accordance with an exemplary embodiment as depicted in FIG. 1, RF Site 104 is a digital two-way radio communications site, such as an ASTRO site, RF Site 105 is a digital two-way radio communications site, such as a MotoTRBO site, and Dispatch Site 106 is a dispatch site. Sites 104-106 can be any of various technologies, such as Land Mobile Radio or cellular technologies, such as LTE.

Sites 104-106 provide wireless communications for subscribers such as mobile devices. Sites 104-106 are each operably coupled to Cloud-Based Communication Application 101.

FIG. 2 depicts a cloud platform in accordance with an exemplary embodiment of the present invention. In the exemplary embodiment depicted in FIG. 2, Cloud-Based Communication Application 101 includes an electronic processor 204, a storage device 206, and a communication interface 208. Electronic processor 204, storage device 206, and communication interface 208 communicate over one or more communication lines or buses. Wireless connections or a combination of wired and wireless connections are also possible.

Electronic processor 204 may include a microprocessor, application-specific integrated circuit (ASIC), field-programmable gate array, or another suitable electronic device. Electronic processor 204 obtains and provides information (for example, from storage device 206 and/or communication interface 208), and processes the information by executing one or more software instructions or modules, capable of being stored, for example, in a random access memory (“RAM”) area of storage device 206 or a read only memory (“ROM”) of storage device 206 or another non-transitory computer readable medium (not shown). The software can include firmware, one or more applications, program data, filters, rules, one or more program modules, and other executable instructions. Electronic processor 204 is configured to retrieve from storage device 206 and execute, among other things, software related to the control processes and methods described herein.

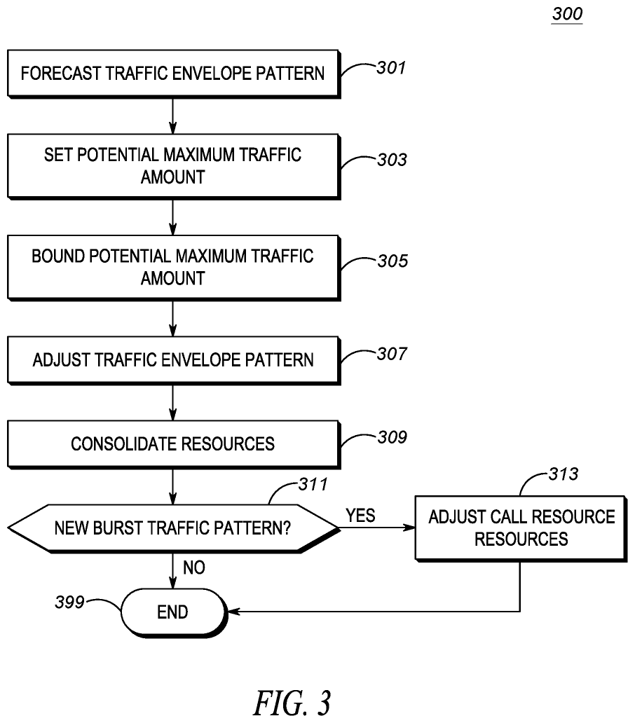

Storage device 206 can include one or more non-transitory computer-readable media, and may include a program storage area and a data storage area. The program storage area and the data storage area can include combinations of different types of memory, as described herein. In the embodiment illustrated, storage device 206 stores, among other things, instructions for the processor to carry out the method of FIG. 3.

Communication interface 208 may include a transceiver (for example, an LTE modem, an FM transceiver, or a Wi-Fi or Ethernet transceiver) for communicating with RF Site 104, RF Site 105, or Dispatch Site 106. Communication interface 208 can also communicate with communication networks.

FIG. 3 depicts a flowchart 300 of a method for allocating resources in a cloud-based communication application in accordance with an exemplary embodiment of the present invention. In accordance with this exemplary embodiment, the cloud-based communication application periodically predicts the cloud resources needs and adjusts the desired state configurations based upon this need. In accordance with a further exemplary embodiment, the cloud-based communication application predicts the cloud resources needs and adjusts the desired state configurations based upon incident event triggers. In accordance with a further exemplary embodiment, the cloud-based communication application predicts the cloud resource needs and adjusts the desired state configurations based upon massive infrastructure or user configuration changes.

Cloud-based communication application 101 forecasts (301) a traffic envelope pattern. In accordance with an exemplary embodiment, cloud-based communication application 101 forecasts the traffic envelope pattern across Cloud-Based Communication System 100 via machine learning. Cloud-based communication application 101 preferably forecasts utilizing unsupervised machine learning. The accuracy of the traffic envelope pattern will increase as more data is collected. Resources are modified based on learned and predicted patterns. In an exemplary embodiment, the traffic envelope pattern is a weighted mixture of different traffic types. In this exemplary embodiment, call signaling and voice processing traffic has a higher weight than resource management traffic.

Cloud-based communication application 101 sets (303) a potential maximum traffic amount. In accordance with an exemplary embodiment, cloud-based communication application 101 sets the potential maximum traffic amount using at least cloud platform information and call properties.

Cloud-based communication application 101 bounds (305) the potential maximum traffic amount, preferably using bounding parameters. In accordance with an exemplary embodiment, the bounding parameters at least one of a count of users, configured capabilities (such as voice, data, or location), user configurations, system infrastructure information, data service capability, call properties, consoles count, sites count, active channels count, failed channels count, number of sites per call, number of consoles per call, active talkgroups count, active talkgroups capabilities; and infrastructure configurations (such as number of sites and number of channels and channels capability, or call properties such as number of sites involved in a call, call type and corresponding durations).

Cloud-based communication application 101 adjusts (307) the traffic envelope pattern based on an incident context. In accordance with an exemplary embodiment, the incident context includes a type, a location, impacted sites, impacted channels, impacted systems, and an historical traffic pattern. The incident context, or trigger, can comprise a national emergency being declared, a planned social event, a particular forecasted weather situation, or a learned incident from RSS feeds or any crowd-sourced social network. The historical traffic patterns can comprise historical behaviors of a traffic envelope pattern regarding a similar incident context.

Cloud-based communication application 101 consolidates (309) resources. In accordance with an exemplary embodiment, cloud-based communication application 101 consolidates resources by determining at least one availability zone that includes a system that is able to add capacity based on the at least one availability zone and the incident context. Cloud-based communication application 101 then increases capacity on the at least one availability zone. Cloud-based communication application 101 preferably increases capacity by creating containers on the at least one availability zone. Cloud-based communication application 101 allows proper lead time to change the desired state and to create and deploy containers.

Cloud-based communication application 101 determines (311) if there is a new burst traffic pattern. If it is determined that there is not a new burst traffic pattern, the process ends (399). In accordance with an exemplary embodiment, cloud-based communication application 101 performs passive performance monitoring to determine if there is a new burst traffic pattern. For example, cloud-based communication application 101 determines that there is a new burst traffic pattern when resource utilization reaches a predetermined percentage. In one exemplary embodiment, this predetermined percentage is 70%. In a second exemplary embodiment, cloud-based communication application 101 determines that there is a new burst traffic pattern, in this exemplary embodiment a lower need of resources, when the resource utilization drops below a predetermined percentage, such as below 15%.

If cloud-based communication application 101 determines that there is a new burst traffic pattern in step 311, cloud-based communication application 101 adjusts (313) call resource resources. In accordance with an exemplary embodiment, when a new burst pattern occurs, cloud-based communication application 101 triggers additional resource allocation that has not been learned from prior traffic data. The process then ends (399).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for allocating resources in a cloud-based communication system, the method comprising:
forecasting a traffic envelope pattern across a cloud-based communication system via machine learning;
setting a potential maximum traffic amount for the cloud-based communication system using at least cloud platform information and call properties;
bounding the potential maximum traffic amount using bounding parameters;
adjusting the traffic envelope pattern based on an incident context;
consolidating resources within the cloud-based communication system; and
adjusting call resource resources in the cloud-based communication system when passive performance monitoring indicates a new burst traffic pattern.

2. The method of claim 1, wherein the step of forecasting comprises forecasting using weighted traffic types.

3. The method of claim 1, wherein the step of forecasting comprises modifying resources.

4. The method of claim 3, wherein the step of modifying resources comprises modifying resources based upon a learned pattern.

5. The method of claim 1, wherein the bounding parameters comprise at least one of a count of users, configured capabilities, user configurations, system infrastructure information, data service capability, call properties, consoles count, sites count, active channels count, failed channels count, number of sites per call, number of consoles per call, active talkgroups count, active talkgroups capabilities; and infrastructure configurations.

6. The method of claim 1, wherein the step of setting a potential maximum traffic amount comprises setting a potential maximum traffic amount based on a count of users.

7. The method of claim 1, wherein the step of setting a potential maximum traffic amount comprises setting a potential maximum traffic amount based on configured capabilities.

8. The method of claim 1, wherein the incident context comprises an incident trigger.

9. The method of claim 1, wherein the incident context comprises historical behaviors of the traffic envelope pattern.

10. The method of claim 1, wherein the incident context comprises a location of the incident.

11. The method of claim 10, wherein the location of the incident comprises at least one of a type of incident, impacted sites, or historical traffic patterns.

12. The method of claim 1, wherein the step of consolidating resources comprises:
determining at least one availability zone, the availability zone comprising a system that is able to add capacity based on the at least one availability zone and the incident context; and
increasing capacity on the at least one availability zone.

13. The method of claim 12, wherein the step of increasing capacity comprises creating containers on the at least one availability zone.

14. A cloud-based communication system for allocating resources, the cloud-based communication system comprising a processor that performs:
forecasting a traffic envelope pattern across a cloud-based communication system via machine learning;
setting a potential maximum traffic amount for the cloud-based communication system using at least cloud platform information and call properties;
bounding the potential maximum traffic amount using bounding parameters;
adjusting the traffic envelope pattern based on an incident context;
consolidating resources within the cloud-based communication system; and
adjusting call resource resources in the cloud-based communication system when passive performance monitoring indicates a new burst traffic pattern.

15. The cloud-based communication system of claim 14, wherein the bounding parameters comprise at least one of a count of users, configured capabilities, user configurations, system infrastructure information, data service capability, call properties, consoles count, sites count, active channels count, failed channels count, number of sites per call, number of consoles per call, active talkgroups count, active talkgroups capabilities; and infrastructure configurations.

16. The cloud-based communication system of claim 14, wherein the step of setting a potential maximum traffic amount comprises setting a potential maximum traffic amount based on at least one of a count of users or configured capabilities.

17. The cloud-based communication system of claim 14, wherein the incident context comprises at least one of an incident trigger, historical behaviors of the traffic envelope pattern, or a location of the incident.

18. The cloud-based communication system of claim 17, wherein the location of the incident comprises at least one of a type of incident, impacted sites, or historical traffic patterns.

19. The cloud-based communication system of claim 14, wherein the step of consolidating resources comprises:
determining at least one availability zone, the availability zone comprising a system that is able to add capacity based on the at least one availability zone and the incident context; and
increasing capacity on the at least one availability zone.

20. The method of claim 19, wherein the step of increasing capacity comprises creating containers on the at least one availability zone.
